(19) United States
(12) Patent Application Publication
(10) Pub. No.: US 2013/0097346 A1
(43) Pub. Date: Apr. 18, 2013

(54) STORAGE DEVICE AND CONNECTING SEAT FOR CONNECTING THE SAME TO HOST

(71) Applicant: INNODISK CORPORATION, New Taipei City (TW)

(72) Inventors: Wei-Cheng HSU, New Taipei City (TW); Chin-Chung KUO, New Taipei City (TW)

(73) Assignee: INNODISK CORPORATION, New Taipei City (TW)

(21) Appl. No.: 13/651,094

(22) Filed: Oct. 12, 2012

(30) Foreign Application Priority Data
Oct. 14, 2011 (TW) 100137249
Nov. 28, 2011 (TW) 100143473

(51) Int. Cl. G06F 13/42

(52) U.S. Cl. 710/105

(57) ABSTRACT

Provided herein are a storage device and a connecting seat for connecting the storage device to a host. More particularly, the storage device and the connecting seat may be used to transmit at least one SATA protocol data. The storage device comprises a PATA interface connector. The connecting seat is a PATA interface connecting seat that can be installed on a circuit board. A plurality of pins of the connector/connecting seat are defined to be in the true IDE mode and a plurality of pins of the connector/connecting seat are defined to be in the non-true IDE mode. The storage device and the circuit board with the connecting seat thereon communicate through the pins of the connector/connecting seat in the non-true IDE mode. Thereby, the manufacturing cost of the storage device or the host is lowered and the convenience is enhanced.

### CROSS-REFERENCES TO RELATED APPLICATIONS

This application claims the benefit of Taiwan, R.O.C. Patent Application No. 100137249 filed on Oct. 14, 2011 and Taiwan, R.O.C. Patent Application No. 100143473, filed on Nov. 28, 2011, the disclosures of both of which are incorporated by reference herein in their entirety.

1. Field of the Invention

The present invention generally relates to a storage device and a connecting seat for connecting the storage device to a host and, more particularly, to a storage device capable of accessing serial advanced technology attachment (SATA) data and a connecting seat for connecting the storage device to a host.

2. Background of the Invention

ATA protocol has been used as storage media connections between internal storage devices, such as compact flash (CF) memories and solid-state drives (SSD), and the circuit board (mostly, the mother board) in a computer system.

In spite of the above, PATA interfaces remain widely used in industrial and system applications for reasons as described herein:

First, SATA interface connector/connecting seat are much more costly than PATA interface connector/connecting seat.

Second, SATA interface connector/connecting seat use a single-side contact design, as shown in FIG. 1. The storage device 110 and the circuit board 120 connected through SATA interfaces 111/121 may separate or get disconnected due to a shock by external forces, which may cause failure or error of transmitted data. Therefore, SATA interfaces connector/connecting seat using the single-side contact design are less reliable than pin-bridged PATA interfaces.

Conventionally, some circuit boards and/or motherboards are provided with both SATA and PATA interface connecting seats so that storage devices having SATA and/or PATA interface connectors can be accessed. However, this may increase the manufacturing cost because one more connecting seat is required to be installed on the circuit board.

### SUMMARY OF THE INVENTION

It is one object of the present invention to provide a storage device and a connecting seat for connecting the storage device to a host. The storage device comprises a PATA interface connector. The connecting seat is a PATA interface connecting seat that can be installed on a circuit board. The storage device and the circuit board communicate through the PATA interface connector and the PATA interface connecting seat to transmit SATA protocol data.

It is another object of the present invention to provide a storage device and a connecting seat for connecting the storage device to a host. The storage device and the host are connected each other through the PATA interface connector/connecting seat. The storage device conforming to PATA transfer protocol specification or SATA transfer protocol specification may be directly inserted into the PATA interface connecting seat on the circuit board without re-designing the circuit board.

It is another object of the present invention to provide a storage device and a connecting seat for connecting the storage device to a host. The pins of the PATA interface connector and the connecting seat are pin socket/pin foot pairs. When the connector is inserted into the connecting seat, the pin sockets and the pin feet fit very well, which results in high reliability in the contact between the connector and the connecting seat and thus improves the security in data transmission.

To achieve above objects, the present invention provides a storage device, comprising: a controller; at least one storage element for storing data; and a connector being PATA interface, the connector having a plurality of pins of the connector defined to be in a true IDE mode and a plurality of pins of the connector defined to be in a non-true IDE mode, wherein: the pins of the connector defined to be in the true IDE mode conform to PATA protocols; and the pins of the connector defined to be in the non-true IDE mode conform to SATA protocols so that the storage device uses the pins of the connector defined to be in the non-true IDE mode to transmit at least one SATA protocol data.

In one embodiment of the present invention, wherein the connector is a standard specification connector established by compact flash association (CFA), and the pin counts of the connector are 50.

In one embodiment of the present invention, wherein each of the pins of the connector is a pin socket or a pin foot.

In one embodiment of the present invention, wherein the pins of the connector defined to be in the non-true IDE mode comprise a plurality of SATA data pins of the connector so that the storage device uses the SATA data pins of the connector to transmit the SATA protocol data.

In one embodiment of the present invention, wherein the SATA data pins of the connector comprise a TX+ positive data pin, a TX− negative data pin, a RX+ positive data pin and a RX− negative data pin, each being defined in order according to the definition of SATA specification or different from the definition of SATA specification.

In one embodiment of the present invention, wherein the storage device is connected to a connecting seat on a host through the connector, the connecting seat being installed on a circuit board and PATA interface, the connecting seat having a plurality of pins defined to be in a true IDE mode and a plurality of pins defined to be in a non-true IDE mode, wherein: the pins of the connecting seat defined to be in the true IDE mode conforming to PATA protocols; the pins of the connecting seat defined to be in the non-true IDE mode conforming to SATA protocols; and the storage device and the circuit board communicate through the pins of the connector defined to be in the non-true IDE mode and the pins of the connecting seat defined to be in the non-true IDE mode to transmit the SATA protocol data.

The present invention further provides a connecting seat for a host, being installed on a circuit board and PATA interface, the connecting seat having a plurality of pins defined to be in a true IDE mode and a plurality of pins defined to be in a non-true IDE mode, wherein: the pins of the connecting seat defined to be in the true IDE mode conforming to PATA protocols; and the pins of the connecting seat defined to be in the non-true IDE mode conforming to SATA protocols, the circuit board uses the pins of the connecting seat defined to be in the non-true IDE mode to transmit at least one SATA protocol data.

In one embodiment of the present invention, wherein the connecting seat is a standard specification connector established by compact flash association (CFA), and the pin counts of the connecting seat are 50.

In one embodiment of the present invention, wherein each of the pins of the connecting seat is a pin socket or a pin foot.

In one embodiment of the present invention, wherein the pins of the connecting seat defined to be in the non-true IDE mode comprise a plurality of SATA data pins of the connecting seat so that the circuit board uses the SATA data pins of the connecting seat to transmit the SATA protocol data.

In one embodiment of the present invention, wherein the SATA data pins of the connecting seat comprise a TX+ positive data pin, a TX− negative data pin, a RX+ positive data pin and a RX− negative data pin, each being defined in order according to the definition of SATA specification or different from the definition of SATA specification.

### BRIEF DESCRIPTION OF THE DRAWINGS

The objects and spirits of the embodiments of the present invention will be readily understood by the accompanying drawings and detailed descriptions, wherein:

FIG. 1 is a stereogram diagram showing the connection of a storage device and a motherboard using conventional SATA interfaces;

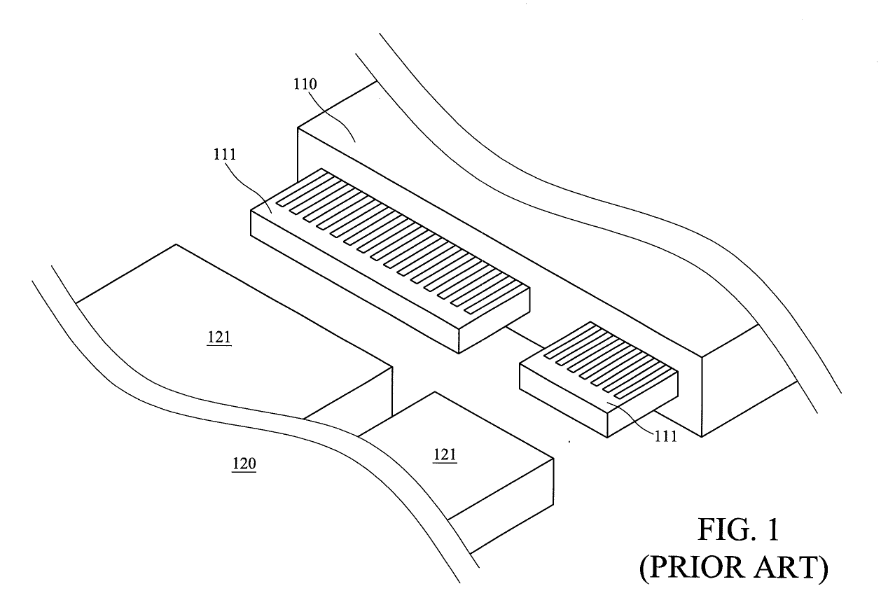

FIG. 2 is a stereogram diagram of a storage device and a connecting seat for connecting the storage device to a host according to the present invention;

FIG. 3 shows the pin arrangement of the connector and the connecting seat according to the present invention;

FIG. 4 is a circuit diagram of a storage device and a connecting seat for connecting the storage device to a host according to one preferred embodiment of the present invention;

FIG. 5 is a table showing the pin definition of the connector and the connecting seat according to one embodiment of the present invention;

FIG. 6 is a table showing the pin definition of the connector and the connecting seat according to another embodiment of the present invention;

FIG. 7 is a table showing the pin definition of the connector and the connecting seat according to another embodiment of the present invention;

FIG. 8 shows a single-row layout pins in the connector of the present invention;

FIG. 9 shows a two-row layout pins in the connecting seat of the present invention; and

FIG. 10 is a circuit diagram of a storage device and a connecting seat for connecting the storage device to a host according to another embodiment of the present invention.

### DETAILED DESCRIPTION OF THE PREFERRED EMBODIMENTS

The present invention may be exemplified but not limited by various embodiments as described hereinafter.

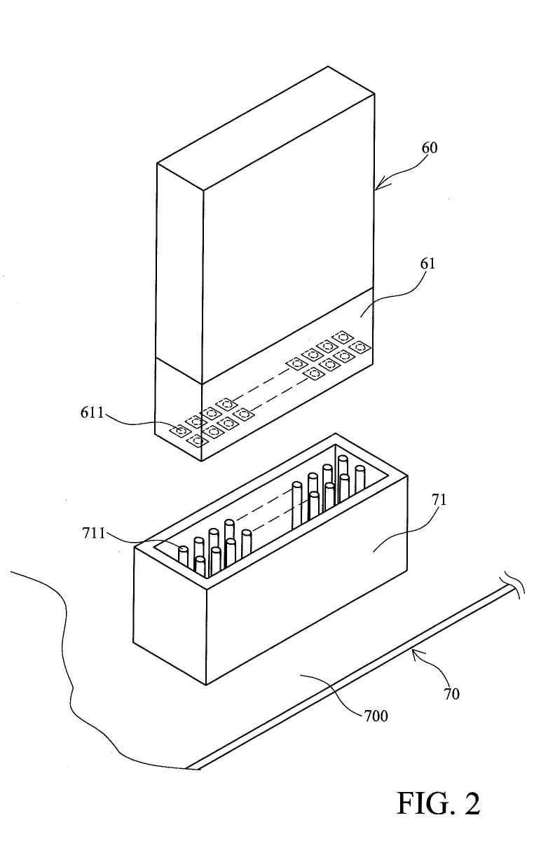

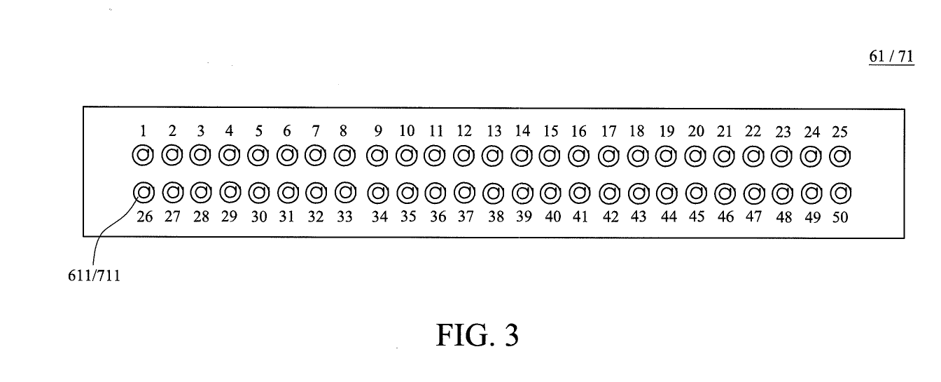

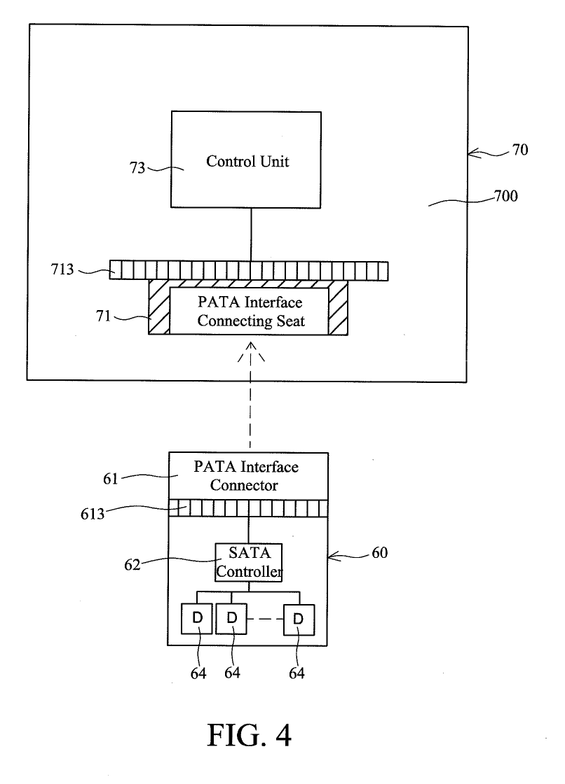

Please refer to FIG. 2, FIG. 3 and FIG. 4 for a stereogram diagram, the pin arrangement and a circuit diagram, respectively, of a storage device and a connecting seat for connecting the storage device to a host according to the present invention. As shown in the figures, the storage device 60 (such as a compact flash (CF) memory, a solid-state drive (SSD) and a hard disk drive (HDD)) is a storage device conforming to SATA transfer protocol specification. The storage device 60 comprises a connector 61, a SATA controller 62 and a plurality of storage elements or electronic elements (D) 64. The storage elements or electronic elements (D) 64 are used for storing data or other purposes. A host 70 (such as a computer system, a digital camera, and a mobile phone) comprises a connecting seat 71 and a control unit 73. The connecting seat 71 can be installed on a circuit board (or a mother board) 700. The control unit 73 is capable of processing the SATA protocol data or PATA protocol data. The storage device 60 and the circuit board 700 communicate through the connector 61 and the connecting seat 71 so as to transmit data.

More particularly, the connector 61 and the connecting seat 71 are both PATA (or IDE) interface. The surface dimensions of the connector 61 and the connecting seat 71 conform to standard specification established by compact flash association (CFA). The pin counts of the connector pins 611 and the connecting seat pins 711 are both 50.

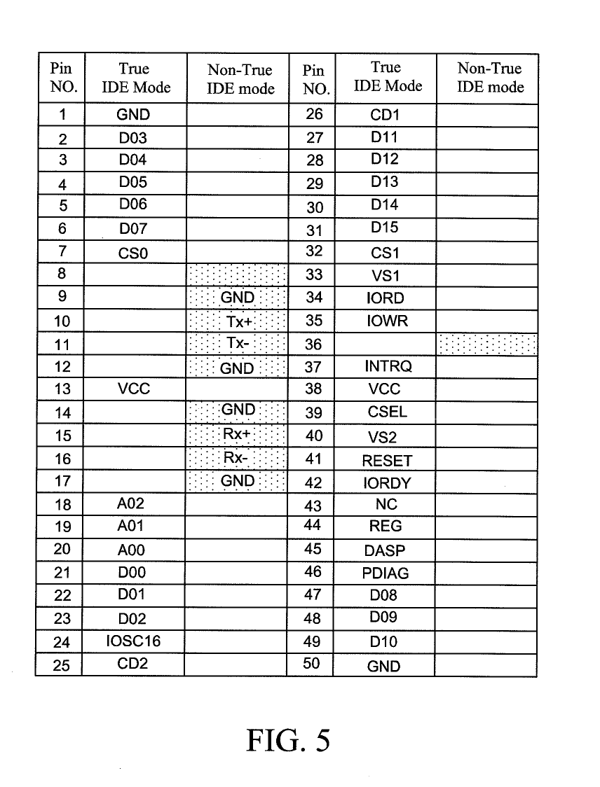

Further refer to FIG. 5 for a table showing the pin definition of the connector and the connecting seat according to one embodiment of the present invention. As stated above, the connector 61 and the connecting seat 71 of the present invention are PATA interface. To conform to general PATA transfer protocol specification, most of the pins 611/711 in the connector 61 and the connecting seat 71 are defined to be in a true IDE mode. For example, the 2^{nd} to 6^{th}, 21^{st} to 23^{rd}, 27^{th} to 31^{st}, 47^{th} to 49^{th} pins are defined as PATA data pins, while the 13^{th}, 38^{th} pins as PATA power pins and the 1^{st} and 50^{th} pins as PATA grounding pins. In other words, the pins in the true IDE mode are used for transmitting PATA protocol data.

The pins 611/711 in the connector 61 and the connecting seat 71 of the present invention further comprise a plurality of pins 611/711 in the non-true IDE mode (undefined as true IDE mode). For example, the 8^{th} to 12^{th}, 14^{th} to 17^{th} and 36^{th} pins 611/711 are defined in the non-true IDE mode to transmit at least one SATA protocol data.

In the embodiment in FIG. 5 of the present invention, the 10^{th}, 11^{th}, 15^{th}, 16^{th} pins are selected from the pins 611/711 in the non-true IDE mode as SATA data pins conforming to SATA transfer protocol specification. For example, the 10^{th} pin is defined as a TX+ positive data pin, the 11^{th} pin as a TX− negative data pin, the 15^{th} pin as a RX+ positive data pin and the 16^{th} pin as a RX− negative data pin.

Furthermore, in the embodiment in FIG. 5 of the present invention, some of the pins 611/711 in the non-true IDE mode are further defined as SATA grounding pins. For example, the 9^{th}, 12^{th}, 14^{th}, 17^{th} pins are defined as SATA grounding pins (GND). By the use of the SATA grounding pins, the SATA protocol data transmitted between the electronic device 60 and the circuit board 700 are immune from electromagnetic interference (EMI) from the circuit board 700 when the connector 61 is inserted into the connecting seat 71.

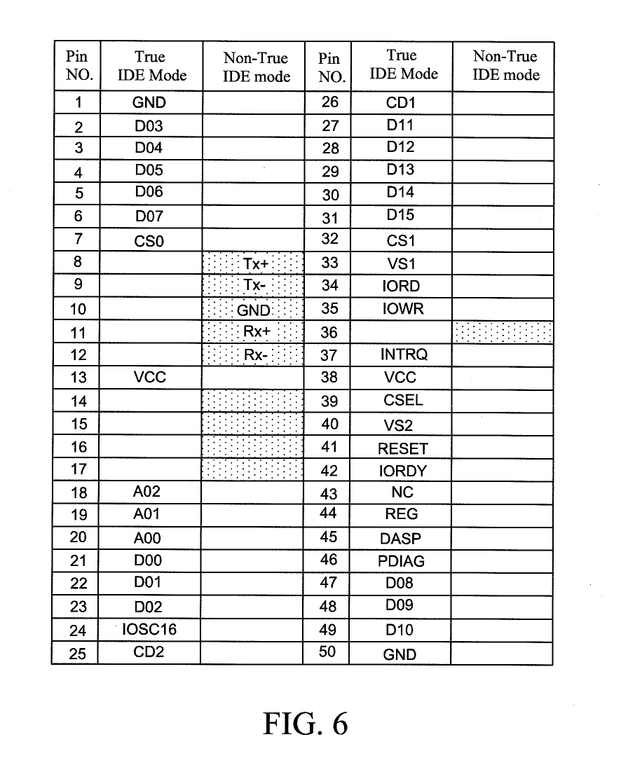

Moreover, in the table in FIG. 6, the consecutive 8^{th} to 12^{th} pins in the pins 611/711 in the non-true IDE mode can also be selected as SATA data pins and SATA grounding pins that conform to SATA transfer protocol specification. For example, the 8^{th} pin is defined as a TX+ positive data pin, the 9^{th} pin as a TX− negative data pin, the 11^{th} pin as a RX+ positive data pin, the 12^{t}h pin as a RX− negative data pin and the 10^{th} pin as a grounding pin.

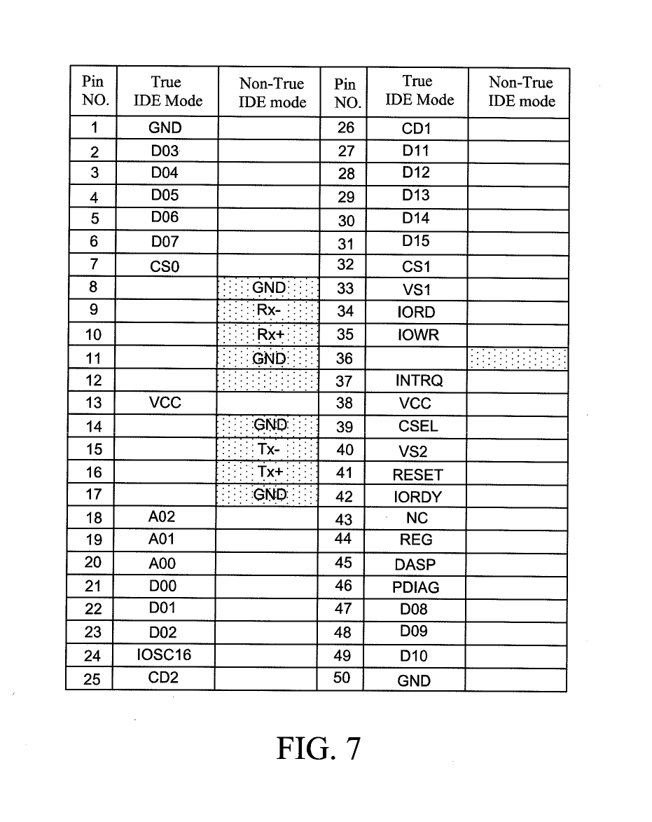

Alternatively, as shown in FIG. 7, the 9^{th}, 10^{th}, 15^{th}, 16^{th} pins of the pins 611/711 in the non-true IDE mode are selected as SATA data pins that do not conform to SATA transfer protocol specification. For example, the 9^{th} pin is defined as a RX− negative data pin, the 10^{th} pin as a RX+ positive data pin, the 15^{th} pin as a TX− negative data pin, the 16^{th} pin as a TX+ positive data pin and the 8^{th}, 11^{th}, 14^{th} and 17^{th} pins as SATA grounding pins (GND).

As stated above, FIG. 5, FIG. 6 or FIG. 7 only describes certain aspects of the present invention. Those with ordinary skills in the art of circuit design may make modifications on the pin layout and select from the pins 611/711 in the non-true IDE mode (for example, the 8^{th} to 12^{th} pins, the 14^{th} to 17^{th} pins and the 36^{th} pin) any pin as a SATA data pin or a SATA grounding pin.

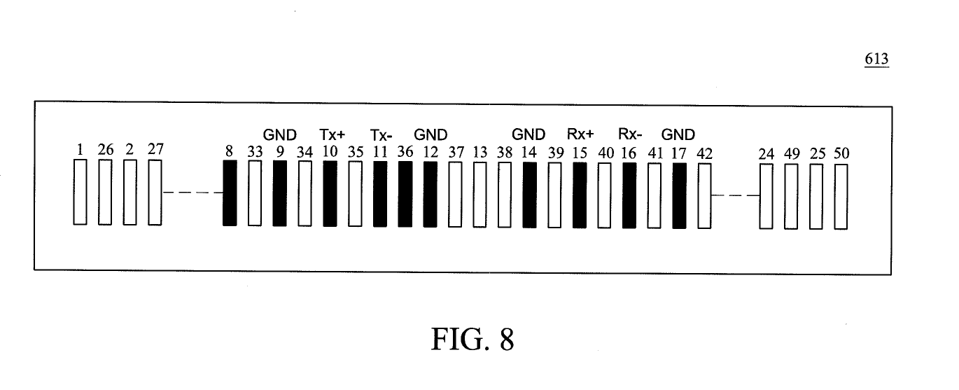

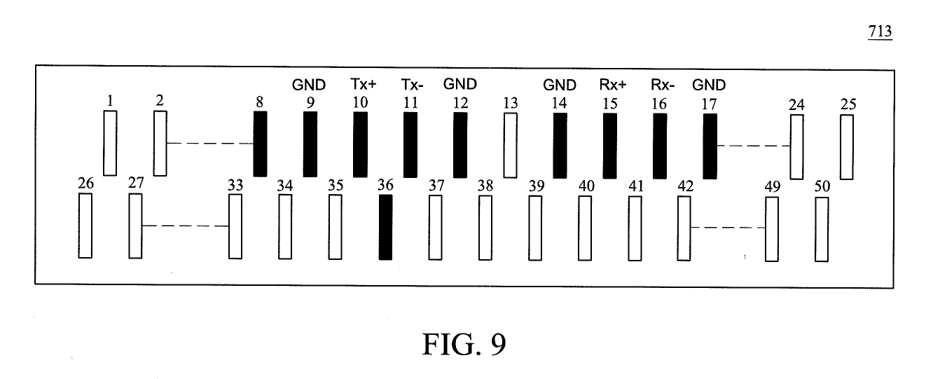

Returning to FIG. 4 and FIG. 5, a layout pin region 613 is provided between the PATA interface connector 61 and the SATA controller 62, while a layout pin region 713 is provided between the PATA interface connecting seat 71 and the control unit 73. The pins 611 in the PATA interface connector 61 are connected to the SATA controller 62 through the single-row layout pins in the layout pin region 613, as shown in FIG. 8. The pins 711 in the PATA interface connecting seat 71 are connected to the control unit 73 through the two-row layout pins in the layout pin region 713, as shown in FIG. 9.

Accordingly, the storage device 60 and the host 70 (or the circuit board 700) communicate to transmit SATA protocol data through the defined SATA data pins (such as the 10^{th}, 11^{th}, 15^{th}, 16^{th} pins) in the PATA interface connector 61 and the connecting seat 71 when the storage device 60 conforming to SATA transfer protocol specification is inserted into the PATA interface connecting seat 71 through the PATA interface connector 61.

In the present invention, SATA protocol data is transmitted from the storage device 60 to the circuit board 700 through PATA interfaces. Since the PATA interfaces are less costly than SATA interfaces, so the manufacturing cost of the storage device 60 and/or the circuit board 700 can be significantly reduced.

Returning to FIG. 2, each of the pins 611 in the PATA interface connector 61 of the present invention is a pin socket or a pin foot. The corresponding pins 711 in the PATA interface connecting seat 71 are pin feet or pin sockets. Therefore, when the connector 61 is inserted into the connecting seat 71, the contact area between the pin sockets and the pin feet can be wider so that the connection between them can be tight and stable. In such a way that improves the security in SATA protocol data transmission.

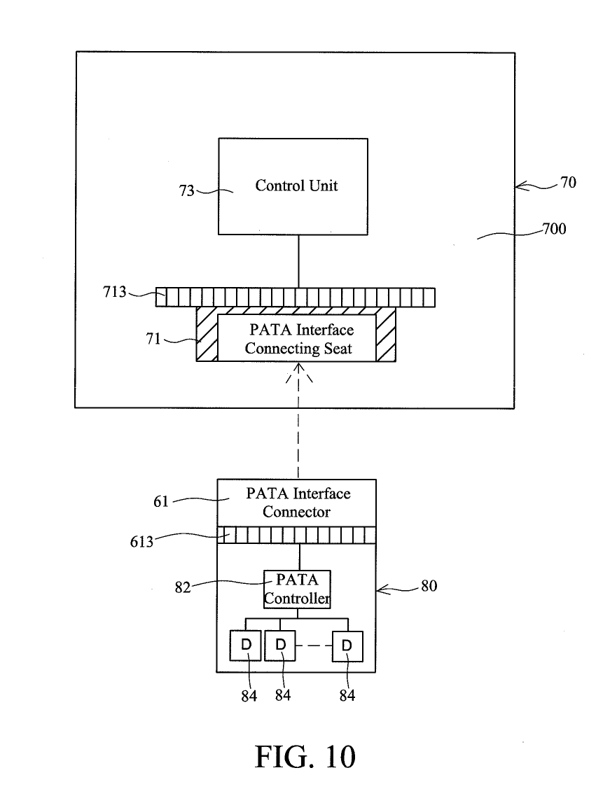

Please refer to FIG. 10 for a circuit diagram of a storage device and a connecting seat for connecting the storage device to a host according to another embodiment of the present invention. In FIG. 10, the present embodiment provides another form of storage device 80 that conforms to PATA transfer protocol specification. The storage device 80 comprises a PATA interface connector 61, a PATA controller 82 and a plurality of storage elements or electronic elements (D) 84. The PATA interface connector 61 is connected to the PATA controller 82 through a layout pin region 613. Each of the storage elements (D) 84 is connected to the PATA controller 82 and is used for storing data or other purposes. The storage device 80 conforming to PATA transfer protocol specification can be inserted into the PATA interface connecting seat 71 through the PATA interface connector 61 to transmit PATA protocol data.

By the use of the present invention, a storage device 60 conforming to SATA transfer protocol specification or a storage device 80 conforming to PATA transfer protocol specification can be inserted into the PATA interface connecting seat 71 on the circuit board 700 through a PATA interface connector 61 without re-designing the circuit board 700, which results in reduced the element cost of the circuit board 700 used in data transfer.

The foregoing description is merely one embodiment of the present invention and not considered as restrictive. All equivalent variations and modifications in shape, structure, feature, and spirit in accordance with the appended claims may be made without in any way from the scope of the invention.

What is claimed is:

1. A storage device, comprising:
a controller;
at least one storage element for storing data; and
a connector being PATA interface, said connector having a plurality of pins of said connector defined to be in a true IDE mode and a plurality of pins of said connector defined to be in a non-true IDE mode, wherein:
said pins of said connector defined to be in said true IDE mode conform to PATA protocols; and
said pins of said connector defined to be in said non-true IDE mode conform to SATA protocols so that said storage device uses said pins of said connector defined to be in said non-true IDE mode to transmit at least one SATA protocol data.

2. The storage device as recited in claim 1, wherein said connector is a standard specification connector established by compact flash association (CFA), and the pin counts of said connector are 50.

3. The storage device as recited in claim 1, wherein each of said pins of said connector is a pin socket or a pin foot.

4. The storage device as recited in claim 1, wherein said pins of said connector defined to be in said non-true IDE mode comprise a plurality of SATA data pins of said connector so that said storage device uses said SATA data pins of said connector to transmit said SATA protocol data.

5. The storage device as recited in claim 4, wherein said SATA data pins of said connector comprise a TX+ positive data pin, a TX− negative data pin, a RX+ positive data pin and a RX− negative data pin, each being defined in order according to the definition of SATA specification or different from the definition of SATA specification.

6. The storage device as recited in claim 1, wherein said storage device is connected to a connecting seat on a host through said connector, said connecting seat being installed on a circuit board and PATA interface, said connecting seat having a plurality of pins defined to be in a true IDE mode and a plurality of pins defined to be in a non-true IDE mode, wherein:
said pins of said connecting seat defined to be in said true IDE mode conforming to PATA protocols;
said pins of said connecting seat defined to be in said non-true IDE mode conforming to SATA protocols; and
said storage device and said circuit board communicate through said pins of said connector defined to be in said non-true IDE mode and said pins of said connecting seat defined to be in said non-true IDE mode to transmit said SATA protocol data.

7. A connecting seat for a host, being installed on a circuit board and PATA interface, said connecting seat having a plurality of pins defined to be in a true IDE mode and a plurality of pins defined to be in a non-true IDE mode, wherein:
said pins of said connecting seat defined to be in said true IDE mode conforming to PATA protocols; and
said pins of said connecting seat defined to be in said non-true IDE mode conforming to SATA protocols, said circuit board uses said pins of said connecting seat defined to be in said non-true IDE mode to transmit at least one SATA protocol data.

8. The connecting seat as recited in claim 7, wherein said connecting seat is a standard specification connector established by compact flash association (CFA), and the pin counts of said connecting seat are 50.

9. The connecting seat as recited in claim 7, wherein each of said pins of said connecting seat is a pin socket or a pin foot.

10. The connecting seat as recited in claim 7, wherein said pins of said connecting seat defined to be in said non-true IDE mode comprise a plurality of SATA data pins of said connecting seat so that said circuit board uses said SATA data pins of said connecting seat to transmit said SATA protocol data.

11. The connecting seat as recited in claim 7, wherein said SATA data pins of said connecting seat comprise a TX+ positive data pin, a TX− negative data pin, a RX+ positive data pin and a RX− negative data pin, each being defined in order according to the definition of SATA specification or different from the definition of SATA specification.
